(19) United States
(12) Patent Application Publication
(10) Pub. No.: US 2005/0166383 A1
(43) Pub. Date: Aug. 4, 2005

(54) Roof jack

(76) Inventor: Dean Newberry, Davis, CA (US)

Correspondence Address: MAGUIRE LAW OFFICE, 423 E ST., DAVIS, CA, 95616, US

(21) Appl. No.: 10/770,152

(22) Filed: Jan. 31, 2004

(51) Int. Cl. E04D 15/00; B23P 11/00

(52) U.S. Cl. 29/428; 81/45

(57) ABSTRACT

A jack for mounting solar panels and other objects to a roof is disclosed. It has two parts: an elongated substantially planar anchor portion that fits under a roof's shingles, and a mounting curve that supports the solar panel or other equipment. This invention can easily be incorporated into standard roofing practices, since it can be installed before the shingles are installed.

### BACKGROUND OF THE INVENTION

1. Field of the Invention

The present invention relates to equipment for mounting objects such as solar panels onto roofs.

2. Background of the Invention

Many types of objects need to be attached to roofs, such as solar panels and air conditioning units. In response to this need, roof-mounting equipment has been developed, but this traditional equipment suffers from a number of drawbacks.

First, prior art mounting mechanisms often fail to provide air circulation below the roof-mounted equipment. For solar panels, air circulation is necessary to dispel heat and promote maximum electricity production. Good air circulation may also be necessary for air conditioning and heating units. Second, many prior art devices are not strong enough to withstand windy conditions and mounting stresses caused by thermal expansion and contraction. Third, prior art mounting mechanisms tend to cause roof leaks, since they are typically installed onto a finished roof, and holes are drilled into the roof to attach the equipment. Although these holes are caulked or otherwise sealed, leaks nonetheless often develop. Fourth, prior art mounting equipment is often expensive and difficult to install. Finally, prior art mounting equipment tends to be bulky and unsightly. The present invention overcomes these shortcomings, as explained below.

### SUMMARY OF THE INVENTION

The present invention is a jack for mounting solar panels and other objects to a roof. It includes an elongated substantially planar anchor portion for under-shingle attachment to the roof, and a mounting curve for support of a solar panel or other object. This jack is easily integrated into conventional roofing practices, since it can be installed before the roof shingles are laid.

### BRIEF DESCRIPTION OF THE DRAWINGS

FIG. 1 is a perspective view of a roof jack according to an embodiment of the present invention, installed on a shingle roof and attached to a solar panel.

FIG. 2 is an exploded perspective view of a roof jack according to an embodiment of the present invention, as installed on a shingle roof.

FIG. 3 is a close-up perspective view of a roof jack according to an embodiment of the present invention attached to one type of support rack and solar panel.

FIG. 4 is a close-up perspective view of a roof jack according to an embodiment of the present invention attached to another type of support rack and solar panel.

FIG. 5 is a cross-sectional view of a roof jack according to an embodiment of the present invention, taken along line 5-5 of FIG. 1.

FIG. 6 is a side view of a roof jack according to an embodiment of the present invention.

### DETAILED DESCRIPTION

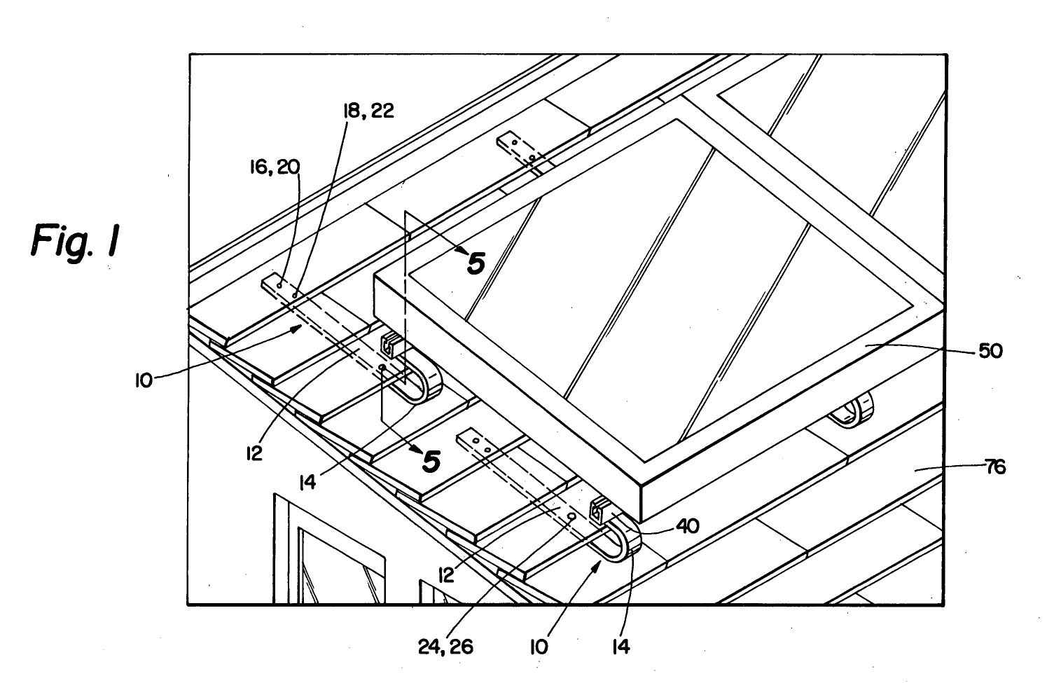

The present invention is a single-piece roof jack 10 with an elongated substantially planar anchor portion 12 and a mounting curve 14. See FIGS. 1, 2, 3, 4, and 6. It can be used to attach a support rack 40 and solar panel 50 to a roof. See FIGS. 1, 2, 3, and 4.

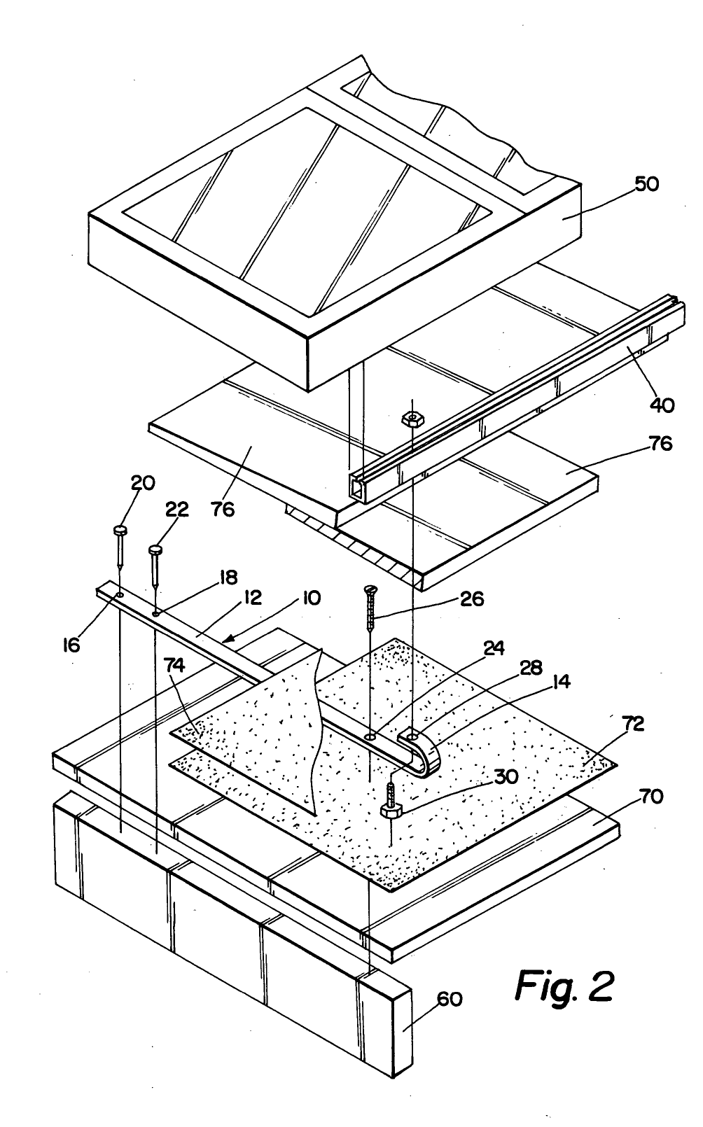

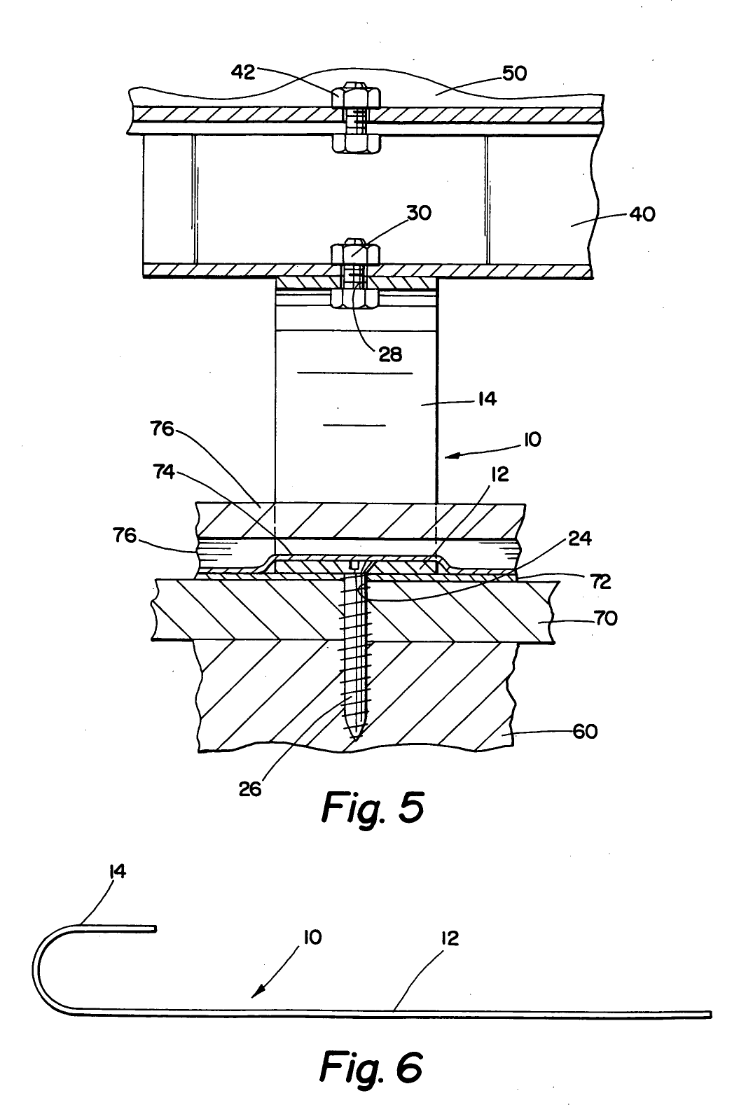

The anchor portion 12 of the roof jack 10 securely attaches to a roof under the shingles. It has rear attachment apertures 16 and 18 to accept rear fasteners 20 and 22 and a front attachment aperture 24. See FIGS. 1, 2. Two rear fasteners 20, 22 and one front fastener 26 fit through their respective attachment apertures and ultimately into the roof rafter 60. See FIGS. 1, 2, 4, 5. In one embodiment, the rear apertures 16, 18 are ⅛ of an inch in diameter, the front aperture is 9/32 inch in diameter, and the fasteners 20, 22, 26 are appropriately-sized flat head stainless steel screws. See FIGS. 1, 2, 4, 5. The apertures 16, 18, 24 may also be beveled or chamfered, to ensure that the roof jack's fasteners do not protrude and tear the tar paper. See FIG. 5. The apertures 16, 18, 24 and fasteners 20, 22, 24 are merely examples of the types of structure that can be used to attach the anchor portion to the roof. Other means for attaching the anchor portion 12 to the roof rafter 60 include adhesives, braces, and other conventional fasteners.

The distance from the rear attachment aperture 18 to the front attachment aperture 24 is great enough to permit a user to install tar paper or roofing felt and shingles underneath and on top of the roof jack 10. In one embodiment, this distance is approximately 17 inches. The distance between the rear attachment aperture 18 to the front attachment aperture 24 allows the roof jack 10 to integrate easily with standard construction practices used by mechanical and roofing contractors. More particularly, the mechanical or solar contractor can initially attach only the rear attachment apertures 16, 18. Then the roofing contractor can lift the front end of the jack to create space for the placement of roofing felt or tar paper underneath the roof jack 10. In this way, the present invention allows the installation of solar panels and other roof-mounted objects to be incorporated into standard roofing practices.

The distance between the front attachment aperture 24 and the beginning of the mounting curve 14 should be great enough to allow for a shingle 76 to cover the front attachment aperture 24, thus preventing water leakage through this opening. In one embodiment, the distance between the front attachment aperture 24 and the beginning of the mounting curve 14 is approximately 7.5 inches.

The mounting curve 14 rises above the rooftop as shown in FIGS. 2, 3, 4 and 6. The mounting curve 14 has a rack attachment aperture 28 at its top to accept a rack attachment fastener 30. See FIGS. 2 and 5. In one embodiment, the rack attachment aperture 28 is 3/8 of an inch in diameter so as to correspond with hardware requirements for standard mechanical roof fixtures. Also, in one embodiment, the radius of curvature for the mounting curve 14 is 4 inches. A c-shaped mounting curve is shown in the drawings, but other curves can be used as well.

By using a mounting curve rather than right-angle bends, the jack 10 has a springlike quality that reduces stress on the roofing and support rack 40, and that also reduces the likelihood that the jack itself will crack. The springiness of the jack is also affected by the distance between the front attachment aperture 24 and beginning of the mounting curve 14—as this distance grows the springiness of the jack is increased.

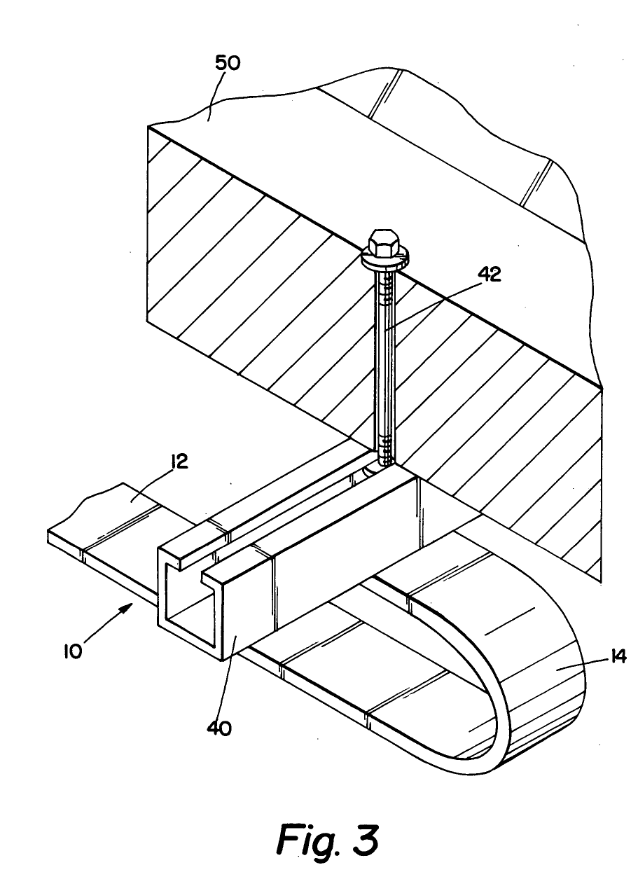

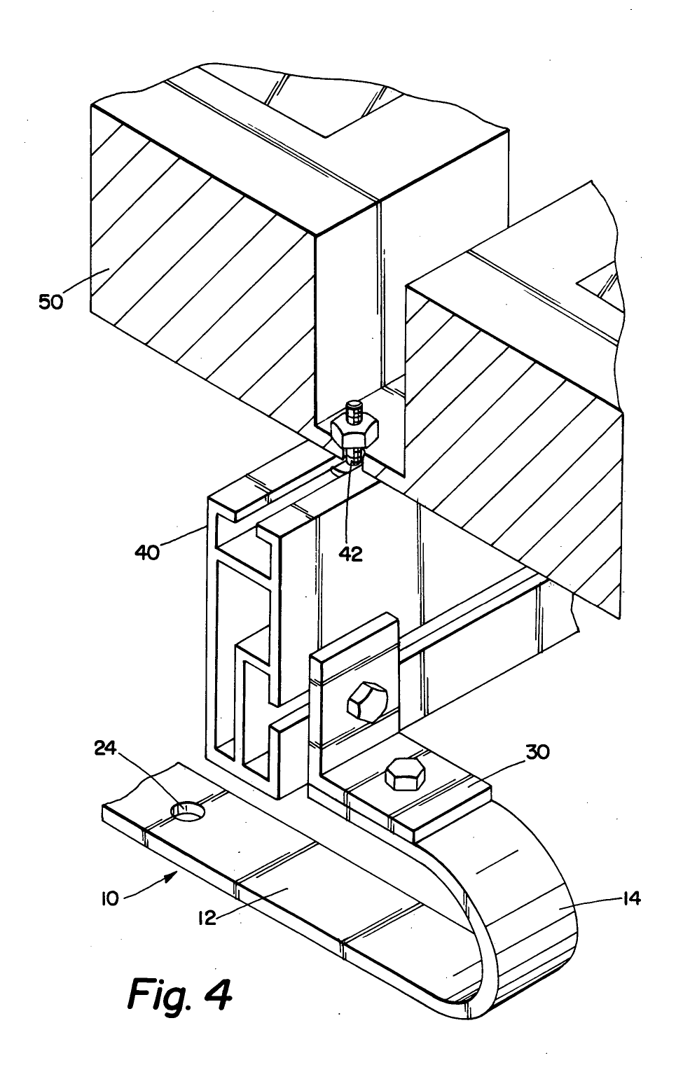

Various different types of support racks 40 can be used with the present invention. Some support racks 40 may affix directly onto the top portion of the upper face of the mounting curve 14, as shown in FIG. 3. Other support racks may be designed so as to affix adjacent and in parallel to, but not on top of, the mounting curve 14, as shown in FIG. 4. Correspondingly, the rack attachment fastener 30 may vary in style so as to securely affix the particularly styled support rack 40 to the roof jack 10. See FIGS. 3 and 4. Thus, the present invention can be used with various types of support racks.

To install the roof jack 10, the user positions the roof jack 10 on top of plywood sheathing 70, and a rafter 60. See FIGS. 2 and 5. The fasteners 20, 22, and 26 are inserted through the corresponding apertures 16, 18 and 24, penetrate the tar paper or roofing felt 72 and the plywood sheathing 70, and securely fasten into the rafter 60. The user then positions a layer or layers of tar paper or roofing felt 74 and shingles 76 over the roof jack 10 in such a way so as to ensure the rack attachment fastener 30 may affix to the support rack 40 through the rack attachment aperture 28. See FIGS. 2 and 5. Finally, the support rack 40 securely attaches to the solar panel 50, or other rooftop device.

The roof jack 10 may be made of different materials, including but not limited to aluminum, bronze, stainless steel, composite carbon, or fiberglass. The roof jack should be thick and stiff enough to resist lifting and twisting from wind, but not so thick that it is difficult to place under shingles. In one embodiment the roof jack is made from ⅛ inch aluminum stock, with a width of about 2^{1/8} inch.

This invention overcomes many disadvantages of the prior art. First, the mounting curve 14 raises the affixed solar panels above the roofing surface, thereby providing the air circulation necessary for efficient solar cell operation. See FIG. 6. Second, the roof jack 10 provides sufficient strength to withstand windy conditions and mounting stresses generated by thermal expansion and contraction. The dimensions of the roof jack 10 are typically thick enough to resist wind lift forces and wide enough to resist lateral rotation under earthquake and wind loads. Additionally, the mounting curve 14 creates a “buggy spring” effect, thereby reducing stresses generated by wind lift and thermal expansion. Third, the present invention eliminates the leaks that result from drilling installation holes in an already-installed roof. By installing the jack 10 underneath the shingles 76, no holes need to be drilled into exposed shingles. Additionally, the shingles 76 cover the apertures 16, 18, 24 and fasteners 20, 22, 26, thereby preventing another possible route for leaking water.

Fourth, this invention can be inexpensively manufactured and easily and quickly installed with simple hand tools. Fifth, this device is more aesthetically pleasing than prior art equipment, since a good portion of the roof jack 10 is hidden by shingles 76.

Finally, this invention successfully integrates solar panel installation into conventional roofing practices. Since the jack 10 is installed before the shingles 76 are laid, conventional roofing processes can be used, with the jack easily installed before the shingles are laid, and the solar panels or other equipment attached after the roof is finished.

Although this patent focuses on solar panels, the present invention can be used with other rooftop-mountable objects, including but not limited to, air-conditioners, satellite dishes, air handler units, signs, lighting, safety catwalks, electrical tubing, plumbing piping, air conditioning distribution tubing, radio antennas, and other devices.

1.) A jack for mounting an object to a roof, comprising:
an elongated substantially planar anchor portion for fitting under shingles of a roof; and
a mounting curve beginning at one end of said elongated substantially planar anchor portion.

2.) The jack according to claim 1, wherein a substantial portion of said mounting curve is substantially parallel to said elongated substantially planar anchor portion.

3.) The jack according to claim 2, wherein said mounting curve is c-shaped.

4.) The jack according to claim 3, additionally comprising a front attachment means, wherein the distance between said front attachment means and said mounting curve is sufficient to allow a shingle to placed over said front attachment means.

5.) The jack according to claim 4, wherein said front attachment means comprises at least one aperture in said jack and at least one fastener.

6.) The jack according to claim 5, wherein said jack is made of metal.

7.) The jack according to claim 6, wherein said jack is made of plastic.

8.) The jack according to claim 4, wherein the distance between said front attachment means and said mounting curve is approximately 7.5 inches.

9.) A kit for mounting a solar panel to a roof, comprising:
a jack according to claim 1, 2, 3, 4, 5, 6, 7, or 8; and
at least one support rack fastener for fastening a support rack to said mounting curve.

10.) A method for mounting a solar panel to a roof, comprising
providing a jack according to claim 1, 2, 3, 4, 5, 6, 7, or 8;
attaching said jack to a roof;
laying at least one shingle over a substantial portion of said elongated substantially planar anchor portion of said jack; and
fastening a rooftop object to the top of said curved mounting portion.

11.) The method of claim 10, further comprising placing roofing felt both under and on top of said jack.

12.) The method according to claim 11, wherein no roof jack attachment holes are drilled into exposed portions of said roof after shingles are installed on the roof.

13.) A roof jack for attaching solar panels or other objects to a roof with shingles, comprising:
a jack anchor portion installed under at least one of said shingles; and
a springlike jack mounting portion rising above said shingles.

14.) A method of reducing the stress experienced by a roof-mounted object, comprising:
providing a springlike roof jack;
attaching said springlike roof jack to a roof; and
attaching said object to said roof jack, so that said object and said jack can accommodate movement from wind and other conditions.

15.) The method according to claim 14, wherein a substantial portion of said springlike roof jack is attached under shingles attached to said roof.
